(19) United States
(12) Patent Application Publication
(10) Pub. No.: US 2008/0183627 A1
(43) Pub. Date: Jul. 31, 2008

(54) Filtered healthcare payment card linked to tax-advantaged accounts

(75) Inventors: Sarah Harrison, New York, NY (US); Mark Keck, New York, NY (US); Sunil Sachdev, New Rochelle, NY (US); Margaret A. Miller, Land O Lakes, FL (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/698,955

(22) Filed: Jan. 29, 2007

(51) Int. Cl. G06Q 20/00; H04L 9/28; G06Q 50/00

(52) U.S. Cl. 705/67

(57) ABSTRACT

A system, method and computer program product for linking healthcare purchases to tax advantaged accounts by means of a card containing a card member's data. The system assists in substantiating eligible expenses for participating card holders. The system leverages existing data feeds. By flagging eligible purchases, the invention aids in automation of the rebate/claims process thereby leading to a faster substantiation of claims and hence, improving customer satisfaction. The individual card member, the card company and a service providing merchant can also communicate through a common platform like a third party website to manually substantiate any pending claims corresponding to purchases. The invention circumvents the need for a card member to use electronic payment cards at only eligible health care merchants and assists individual card members in getting benefits for eligible purchases made using the electronic card at non-healthcare merchants.

### BACKGROUND OF THE INVENTION

1. Field of the Invention

The present invention generally relates to the field of making payments for health care purchases at healthcare and non-healthcare merchants and to providing tax advantages to a card member for eligible items in a purchase, independent of the retailer from whom that purchase was made.

2. Related Art

In recent times, the Internal Revenue Service (IRS) has allowed various healthcare items, like medicines and medical equipments, to be deemed eligible for tax advantaged accounts (TAAs) like Flexible Savings Account (FSA), Heath Reimbursement Arrangement (HRA) or Health Savings Account (HSA) benefits for a card holder. An HRA or an HSA account is funded by an employer, whereas an FSA or an HSA account is funded from an employee's own salary. The employee gets tax deductions for funds put into the HRA or the HSA account.

However, the IRS has restricted the usage of payment cards when accessing the funds from tax advantaged accounts for substantiation of any tax benefits associated with these accounts to only those merchants and service providers that have a valid Merchant Category Code (MCC) related to healthcare (i.e., physicians, pharmacies, dentists, vision care offices, hospitals or other medical care providers). The IRS has reiterated this point in a recent guidance issued in year 2006 and has stated that Third Party Administrators (TPAs) of these accounts and card holders must comply with these guidelines. Further, the IRS has ruled that after Dec. 31, 2007, payment cards may not be used at any store, vendor or merchant that does not have related MCCs (that is, any non-healthcare merchant in general), unless the store, vendor or merchant has implemented an inventory information approval system. In addition, after Dec. 31, 2008, the IRS requires the above mentioned compliance on a “store location by store location” basis for retail pharmacies or stand-alone pharmacies that have less than 90% of their inventory falling under the category of healthcare items.

This guidance severely limits where an individual can utilize a payment card linked to tax advantaged accounts like FSA or HRA accounts, for purchases made. Such a limitation can restrict the card holder to using other financial instruments for healthcare purchases, that otherwise would have been eligible for benefits, if the merchant selling the item does not have a valid MCC and is a non-healthcare merchant. The card holder, though may file a claim later on and get reimbursed for it. Though the IRS has allowed the transaction to take place at a non-healthcare merchant, it requires the merchant to implement an inventory information approval system (e.g., line item details) at the merchant's point of sale (POS). This ensures that identification of eligible items happens substantially in real-time. Such an implementation will require significant changes to a merchant's POS solution. Additionally, conventional procedures require a lot of paperwork to be submitted by a card holder to get reimbursement for healthcare purchases leading to a slow, error-prone and resource intensive payment process.

Given the foregoing, what is needed is a system, method and computer program product for circumventing restrictions on the usage of a payment card by a card holder or an individual for healthcare purchases made at healthcare and non-healthcare merchants. Further, the system, method and computer program product should be able to provide a means for complete transaction execution including payments for eligible and non-eligible items, dynamically in real time or offline (for transactions that cannot be substantiated right away at a POS device). The card holder should also be able to substantiate and track transaction details for purchases deducted from his or her tax advantaged accounts, like the FSA, HRA or HSA accounts, by means of a website or a portal.

### SUMMARY OF THE INVENTION

The present invention meets the above-mentioned needs by providing a system, method and computer program product for substantiating eligible expenses related to participating card holders for purchases made at healthcare and non-healthcare merchants. The card holder possesses a card that acts as a filtered multi-purpose payment card. The card can be used at healthcare and non-healthcare merchants, like retail stores. A TPA monitors purchases made on a continuous basis and auto-substantiates transactions whenever possible. Any substantiated purchases of eligible items would be automatically deducted from the card holder's tax advantaged accounts (like, for example, FSA, HRA or HSA accounts). Unsubstantiated purchases would be directly added to the card holder's line of credit account and would also be communicated to the card holder via a TPA website or portal, or via letter and emails to the individual card holder to substantiate any claims associated with a purchase. Further, the card holder can request amounts associated with specific purchased items to be automatically deducted from their tax advantaged accounts like FSA, HRA or HSA accounts. Any amount that remains unsubstantiated can be billed to the card holder's line of credit account with an associated issuer or company. Eligible payments in this process can be deducted from a card holder's tax advantaged account like FSA, HSA or HRA account either automatically or upon request, depending upon the settings selected by the card holder on a TPA website or a portal.

Purchases that are made at healthcare merchants (having valid MCC codes) but are not eligible for any FSA, HRA or HSA benefits can be rolled over to the card holder's line of credit account with the associated issuer or company to resolve the ineligible spend. After a certain period of time, unsubstantiated charges would be billed by the issuer or company to the card holder in a similar manner as any non-healthcare remittance.

Additionally, the process may leverage existing data feeds to capture inventory details like line item details (LID) at a point of sale (POS) terminal of a merchant, irrespective of the merchant having a valid MCC code. Further, the process does not require the merchant to install any new hardware or software to automatically authorize the use of payment cards.

Various embodiments of the present invention provide a system, method and computer program product for substantiating, in a secure way, eligible expenses for participating card holders. Substantiation can take place by various means like LID, matching co-payment amounts, feed from pharmacy benefits managers, or the like, well known to one skilled in the art. The various embodiments may also include performing one or more of the aforementioned functions independently and in any order, as per the need.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 illustrates a sample receipt containing line-item-details for a purchase made by a card holder, according to one embodiment of the invention;

FIG. 2 is an exemplary environment showing various elements involved in the implementation of health care card payment method, according to an embodiment of the present invention;

FIG. 3A illustrates a process of authorization of payment card, according to an embodiment of the invention.

FIG. 3B illustrates a process where all purchases associated with a payment card are charged to a line of credit, according to yet another embodiment of the invention.

FIG. 4A illustrates a process of claims settlement.

FIG. 4B illustrates a process of claims settlement when a line of credit account is directly charged

FIG. 5 illustrates a process of manual claims settlement, according to another embodiment of this invention.

FIG. 6A illustrates a process for updating the status of various claims according to yet another embodiment of the present invention.

FIG. 6B illustrates an alternative process for updating the status of various claims.

FIG. 7 is a block diagram of an exemplary computer system useful for implementing the present invention.

### DETAILED DESCRIPTION

### I. Overview

The detailed description herein makes reference to the accompanying drawings and figures, which show exemplary embodiments of the invention by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention is directed to a system, method and computer program product for providing benefits linked with tax advantaged accounts to eligible card holders, based on purchases made by them at healthcare and non-healthcare merchants. Further, the present invention may perform encryption and decryption of all data items during transmission to enhance the security of the overall process. It is also contemplated that substantiation of purchases for eligible transactions for various FSA, HRA or HSA benefits will be performed on a real time basis or offline over a full-duplex communication channel. Card holders can manually or automatically initiate the substantiation process through, for example, a third party website or portal.

It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

### Terminology

The term “merchant” or “provider” as used herein shall mean any person, entity, distributor system, software, and/or hardware that is a provider, broker, and/or any other entity in the distribution chain of goods or services. For example, a merchant may be a credit card issuer, a hotel chain, an airline, a grocery store, a retail store, a travel agency, a service provider, including, but not limited to, a medical service provider, an online merchant, or the like.

As used herein, an “item” may be one or more of information, good and/or service capable of being exchanged between entities. In addition, an “item identifier” may include, for example, one or more of a universal product code (UPC), a stockkeeping unit (SKU), a serial number, a reference number, a category number, a service type indicator, a requestor name, a price, a description and/or any other information capable of identifying an item.

An “item qualifying for pre-tax treatment” (sometimes also called “a tax-advantaged item”) may include any item that may be purchased with untaxed funds, such as, but not limited to, payroll funds. In one embodiment, an item qualifying for pre-tax treatment is an item included in the Internal Revenue Service Guidelines, which may be changed over time. In addition, an item qualifying for pre-tax treatment may be set and/or changed by any person or entity. Furthermore, an item qualifying for pre-tax treatment may originate at the employer, any third party that may administer a tax-advantaged account, and/or a tax related servicing entity. However, some additional restrictions on coverage may be defined by the employer because the employer may assume the legal risk for some payments. In one embodiment, an information card may be distributed to employees, employers, and/or third party administrators explaining which expenses and/or items qualify for pre-tax treatment.

A “transaction account” as used herein refers to an account associated with an open account card or a closed account card system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use with a particular merchant, a particular chain of merchants or a collection of affiliated merchants. One example of a closed card is a card that may only be accepted at a clothing retailer, such as a Saks Fifth Avenue® store.

The term “transaction instrument” as used herein may include any type of open or closed charge card, credit card, debit card, FSA card, stored value card, an RFID chip based card or token, and the like. For convenience, a transaction instrument may be referred to as a “card.”

An “account,” “account number” or “account code”, as used herein, may include any device, code, number, letter, symbol, digital certificate, mart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder, radio frequency card or payment statement).

A “tax-advantaged account” is generally an account that is established and administered under Sections 125 and/or 132 of the Internal Revenue Code. These include, but are not necessarily limited to consumer-directed healthcare plans (“CDHPs”), such as the Flexible Spending Account (“FSA”); the Health Savings Account (“HSA”); and the Healthcare Reimbursement Arrangement (“HRA”). An example of a tax-advantaged account may be an FSA, an HSA or an HRA account unless specifically indicated otherwise.

A FSA is an account set up to hold the withheld portions, and to pay for certain categories of items that qualify for pre-tax treatment under the Internal Revenue Service Guidelines. As it currently stands, if an employee wishes to, for example, establish both a FSA for qualifying childcare expenses and a FSA for qualifying medical expenses, the employee must establish two FSAs and designate how much of the employee payroll to withhold and credit to each FSA. The employee may then withdraw the funds held in each FSA as the employee purchases qualifying items associated with each respective FSA.

Conventionally, to withdraw funds held in a tax advantaged account for qualifying expenses, the employee typically must first purchase the qualifying item, then request the third party administrator to reimburse the employee for the purchase. More specifically, the employee is usually required to pay for the item at the point of sale, complete and file a claim form along with the sales receipt, wait for the third party administrator to process and approve the claim, and wait to receive reimbursement. Thus, the current process for withdrawing funds from tax advantaged accounts for qualifying expenses is time consuming, requires the employee to be “out of pocket” until reimbursement arrives, and necessitates that the employee perform various tasks after the purchase. Furthermore, in situations where the employee incurs a claim for expenses in different types of FSAs (e.g., a medical expense FSA and a childcare FSA), the employee is generally required to file two claims, one for each respective FSA, following the above steps.

In a typical tax advantaged account, which is the most established of the CDHPs, an employer deducts pre-tax dollars from an employee's paycheck to cover IRS-approved healthcare expenses, and the deducted amount is put in the employee's tax advantaged account. The employee pays for healthcare goods and/or healthcare services (“goods/services”) out of pocket, and submits a receipt for the goods/services for substantiation and reimbursement. A third party administrator (“TPA”) reviews the receipt and confirms the purchase of the goods/services. Once confirmed, the TPA sends a reimbursement check to the employee and the TPA is reimbursed by the employer. Funds in the tax advantaged account that are not used by the employee by the end of the year are forfeited to the employer. TPAs have begun to offer debit cards to employees for payment of healthcare goods/services. These debit cards enable automation of some aspects of claims substantiation.

An HSA works in conjunction with an insurer's health insurance plan, which incorporates employee-paid deductibles. An employer and/or an employee contributes pre-tax dollars to the employee's HSA to cover IRS-approved healthcare expenses. The contributions are allowed to roll over from year to year and to accumulate tax free indefinitely. Funds in the HSA may be transferred from an investment account to a cash account to pay for expenses. When an HSA card or an HSA check is given to a provider for payment of healthcare goods/services, the provider submits a claim to the insurer. The insurer may then, for example, determine the employee's share of the payment, withdraw the determined amount from the employee's cash account, and record that amount as part of the employee's deductible.

In a typical HRA, an employer contributes pre-tax dollars to an employee's HRA. Funds in the HRA may be used to pay for deductibles and/or out-of-pocket medical expenses, and may be used to replace existing healthcare benefits. The employer is allowed to determine factors such as: whether substantiation is required; an allowable annual roll-over amount; whether the HRA is to be fully funded at the beginning of the year; and particular goods/services that are not covered. The employee pays for healthcare goods/services out of pocket, and sends in a receipt for the goods/services for reimbursement, which is from funds in the HRA.

As used herein, the terms “employer”, “end user”, “consumer”, “customer”, “cardmember”, “business” or “merchant” may be used interchangeably with each other, and each shall mean any person, entity, machine, hardware, software or business.

As used herein, “point of sale device” may be any software and/or hardware suitably configured to facilitate a purchase. It may include any means or manner of communicating with one or more host computers for the purpose of making requests for payment or payment authorization. Such means may include, but are not limited to, telephonic means, card readers, computer terminals connected directly to the host computer(s) or indirectly, via e.g., the Internet, or any other means of communication known to persons skilled in the relevant arts.

As used herein, “transmit” may include sending electronic data from one system component to another over a network connection.

Additionally, as used herein, “data” may include encompassing information such as commands, queries, files, data for storage, and the like in digital or any other form.

“Transaction data” may include, for example, one or more of the amount of purchase, at least one payment instrument account number, at least one payment account number, at least one item identifier for each item being purchased, loyalty information, demographic information and/or any other data helpful in processing a transaction.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

The present invention is now described in more detail herein in terms of the above exemplary system, method and computer program product. This is for convenience only and is not intended to limit the application of the present invention. In fact, after reading the following description, it will be apparent to one skilled in the relevant art(s) how to implement the following invention in alternative embodiments.

### II. System

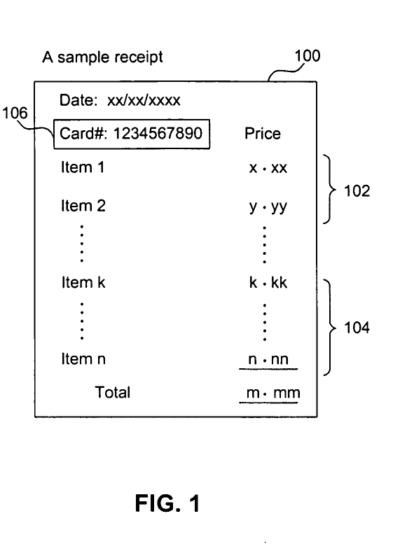

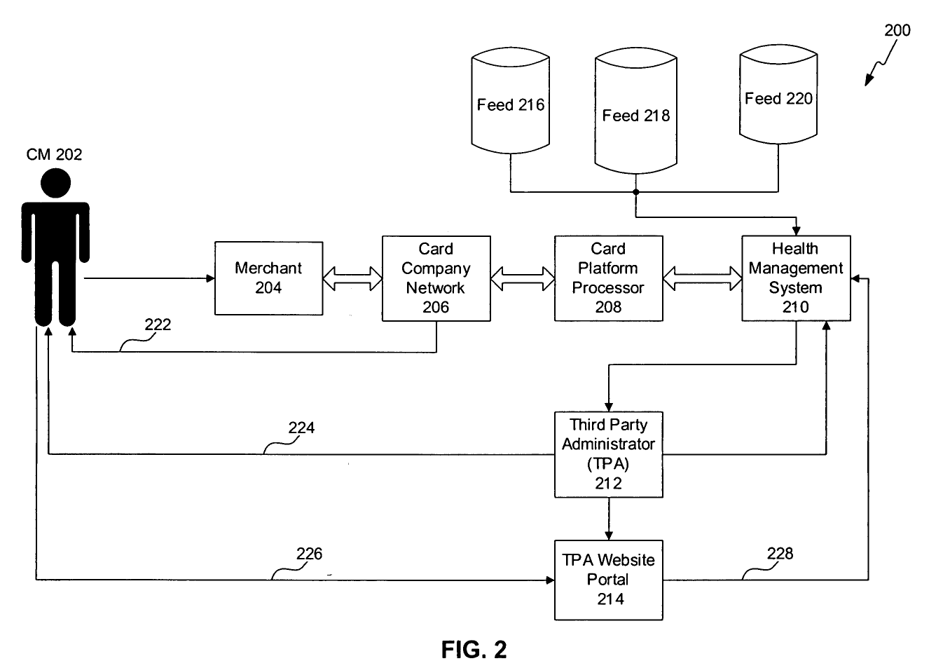

FIG. 1 shows parts of a sample receipt 100 generated when a card holder makes a health care purchase at any merchant. Receipt 100 may be in the form of a paper receipt, an electronic record or any other mechanism that stores a record of the transaction. Sample receipt 100 may also contain, for example, other merchandise not related to a card holder's tax advantaged accounts like healthcare, FSA, HRA or HSA benefits account. As shown in FIG. 1, sample receipt 100 contains, amongst other data items, a card number 106, items 102 and items 104. For example and not by way of limitation, items 102 may be healthcare items that are eligible for tax benefits whereas items 104 are merchandise items which do not qualify for any sort of discounts or benefits. Line item details may be captured from sample receipt 100 and may be provided to a health management system 210, as described with respect to FIG. 2 below.

FIG. 2 illustrates an environment involving a system 200 in which an embodiment of the present invention can be implemented. A card member CM 202 presents a transaction instrument, such as, for example, an electronic card, (not shown in FIG. 1) to a merchant 204 after purchase of healthcare items. The electronic card contains data pertinent to CM 202's healthcare, financial and personal information. The electronic card may be used by CM 202 to directly access his or her tax advantaged accounts like FSA, HRA or HSA accounts as described in the co-pending application titled “Linking Transaction Cards with Spending Accounts” (U.S. application Ser. No. 11/381,641 filed May 4, 2006) for Keck et al, incorporated in its entirety by reference herein. Further, the electronic card may be linked to a card company network 206 that maintains the electronic card.

Merchant 202 can have a valid “Merchant Category Code” (MCC code) that identifies it as a healthcare merchant. An example of a valid MCC code merchant would be a physician providing healthcare services to a CM 202. Alternatively, merchant 204 can be a merchant who does not have a valid MCC code. An example of a merchant without a valid MCC code would be a grocery store. According, to one embodiment of the current invention, CM 202 can use the electronic card at both healthcare merchants with a valid MCC code and non-healthcare merchant without a valid MCC code. This feature of the present invention gives CM 202 a choice of purchasing a healthcare item anywhere without worrying about whether or not he or she can use the electronic card for purchases at any merchant 204.

Merchant 204 has means for reading CM 202 data as stored in the electronic card. Such a means could be, for example, a point-of-sale device (POS device), a wedge card reader, or any other means well known to one skilled in the art. Once data from the electronic card has been read by merchant 204, merchant 202 sends an authorization request to card company network 206. Card company network transfers this request to a card platform processor 208 along with the details of CM 202 as stored on the electronic card.

Card processor platform 208 can verify data related to the authorization request and send a return authorization message and settlement instruction to card company network 206. Card company network 206 can receive authorization and settlement instructions from card processor platform 208 in substantial real-time so that merchant 204 and card company network 206 can settle payments for eligible healthcare purchases made by CM 202 using, for example, binary range data on the electronic card. The settlement and payment process can happen fast enough for CM 202 to perform purchases “on-the-go” as CM 202 might do with general everyday purchases.

Alternatively, card processor platform 208 can send pending charges information to card company network 206. Card company network 206, at an end-of-cycle period can then bill CM 202 in the form of a statement or like, as shown by path 222. A statement of amounts charged can be sent directly to CM 202. Additionally, such a charge can also be applied to any non-substantiated amounts that have been left unclaimed for a predetermined amount of time and a statement can then be sent to CM 202, as shown by path 222.

For purchases that cannot be verified for tax-benefits instantaneously because of lack of data like insurance data or line-item-detail (LID) data, card processor platform 202 forwards transaction details for such purchases made by CM 202 to a health management system 210.

Due to the substantially real-time operation of the authorization and settlement process performed by merchant 204 and card company network 206 in their communication with card processor platform 208, the card processor platform forms the end-point for a front-end substantiation process. Card processor platform 208 will share transaction data back and forth with health management system 210 on a regular (e.g., nightly) basis. For all transactions or purchases for which card processor platform 208 has learned the authorization information, it will communicate with health management system 210 and share information related to authorized transactions. Following this, card processor platform 206 may directly issue an authorization confirmation to merchant 204 via card company network 206. Card processor platform 206 may perform such an authorization confirmation on a group of transactions (i.e., in a batch mode) or on a transaction-by-transaction basis.

Health management system 210 receives data inputs from one or more data feeds like feeds 216-220. Feeds 216-220 can be any of a merchant LID database, a pharmacy benefits manager module or an insurer database, for example and not by way of limitation. A merchant LID database (any one of feeds 216-220) provides health management system 210 with details of items as described in sample receipt 100. In an exemplary scenario, LID data along with insurance data from an insurer database (any one of feeds 216-220) and additional benefits information from a pharmacy benefits manager module (any one of feeds 216-220) are matched up with transaction details provided by card processor platform 208 to health management system 210. On compiling details of the matching process and based on substantiation information, health management system 210 transfers charge purse transaction adjustments back to card processor platform 208 which will incorporate those charges for further communication with CM 202, as shown by path 222.

All charges including those that cannot be substantiated by health management system 210 using inputs from feeds 216-220, are passed by health management system 210 as charge purse transaction details to a third party administrator (TPA) 212.

TPA 212 posts charge purse transaction details on a TPA website portal 214, for CM 202 to take action upon. On receiving transaction details from health management system 210, TPA 212 checks if the purchase has been categorized for processing by CM 202. If yes, then the TPA 212 may optionally chose to send purse adjustment instructions back to health management system 210. If not, TPA 212 can send letters or emails to CM 202 for non-substantiated transactions as shown by path 224. In case of charges that are eligible for tax advantaged account benefits, TPA 212 may select to bill charges to any such tax advantaged account that CM 202 may hold. By doing so, TPA 212 ensures that charges are always in a substantiated status. According to one embodiment of the invention, CM 202 may receive communications regarding all transactions from a statement issued by card company network 206 or TPA 212, or further still by both card company network 206 and TPA 212.

At TPA website portal 214, CM 202 can, via path 226, review all charges to his or her account, request automatic, one-time or manual deductions from his or her tax advantaged account and substantiate various purchases. TPA website portal 214 shows all charges posted to a particular CM 202's account that are pending, charges that have been unclaimed, and those that need to be filed for tax benefits. CM 202 can by use of TPA website portal 214 perform manual or automatic substantiation of charges linked to various transactions and pass them to health management system 210 via path 228. Health management system 210 and/or TPA 212 determine if any charges are eligible for tax benefits per IRS guidelines. In the event that charges are deemed ineligible for benefits, they are moved to a line of credit account associated with the card holder. A line of credit account may be, for example, an account managed by the card company network 206.

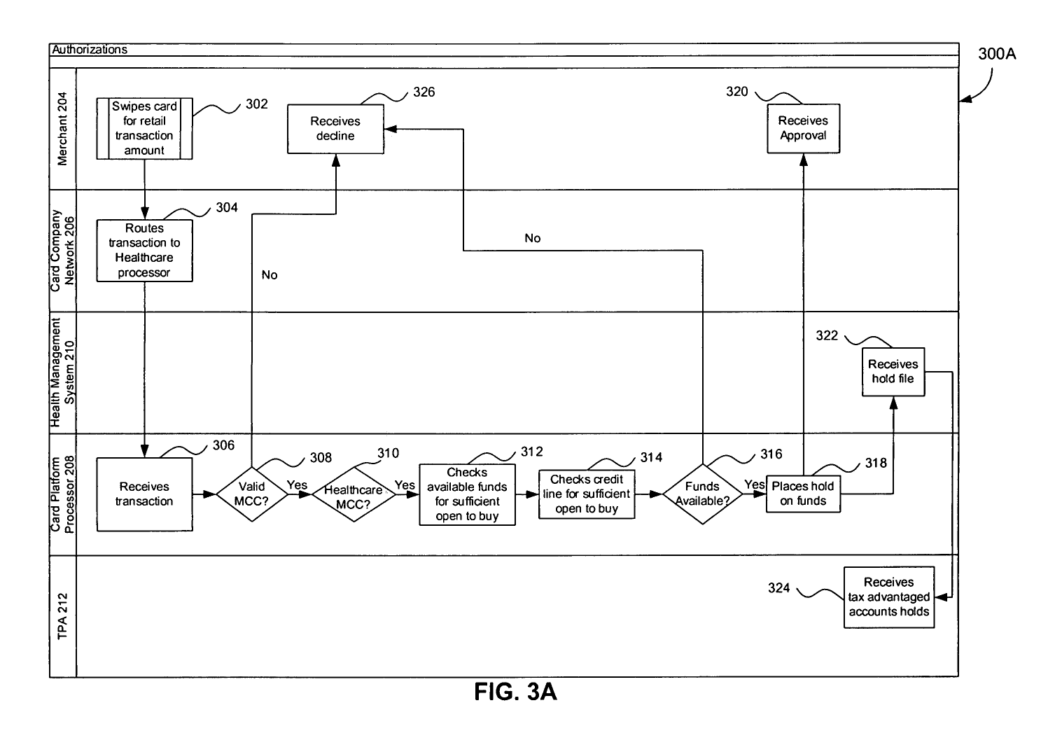

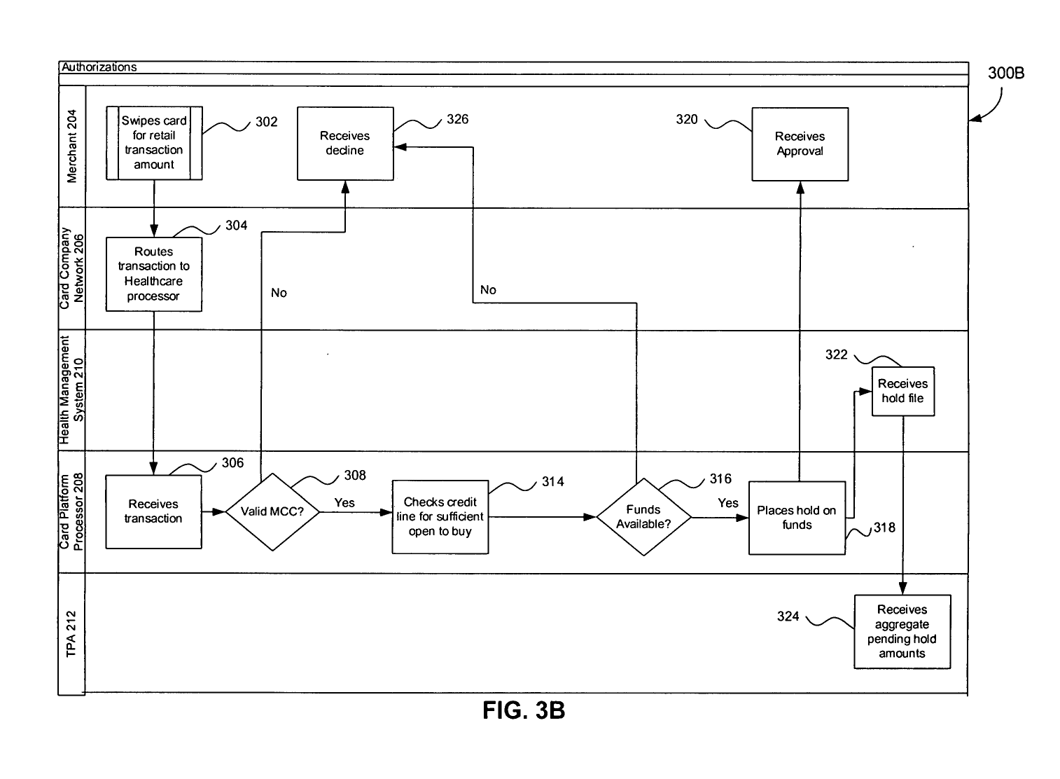

FIG. 3A illustrates a process 300A for authorization of payment card for CM 202. In step 302, either one of CM 202 or merchant 204 swipes a payment card on a card reader (not shown) for the retail transaction amount. The card reader could be, for example and not by way of limitation, a wedge card reader. Information read by the card reader from the payment card, is routed to card platform processor 208 via card company network 206. Card platform processor 208 receives transaction details (as shown in step 306) and in step 308 determines if merchant 204 has a valid MCC or not. If not, merchant 204 receives a decline for authorization, as shown in step 326. Such a decline could be, for example, by means of a message displayed on a card reader screen. If merchant 204 has a valid MCC determined in step 308, card processor platform 208 further decides if merchant 204 falls in a healthcare MCC or not (shown in step 310). If yes, then card processor platform 208 checks the available funds in CM 202's tax advantaged accounts, as shown in step 312. If merchant 204 has a valid MCC, but an invalid healthcare MCC card processor platform 208 checks a line of credit account associated with CM 202 and moves the charge purse to that line of credit account to be cleared by CM 202 at a later time.

FIG. 3B shows an alternative embodiment of the invention as a process 300B, where all purchases made by CM 202 are charged directly to the line of credit account associated with CM 202. In process 300B, card processor platform 208 does not check for a merchant 204 to have a valid healthcare MCC, as shown in box 310 of FIG. 3A. CM 202 can later submit a claim for reimbursement for eligible purchases via, for example, TPA website portal 214.

If in step 316, card processor platform 208 finds that funds are not available in a CM 202's tax advantaged account, card processor platform 208 sends a declined authorization message to merchant 204, as described above.

However, if funds are available in CM 202's tax advantaged account, card processor platform 208 places a hold on those funds, as shown in step 318. Card processor platform 208 then sends an approval of transaction message to merchant 204, as shown in step 320 and also sends a file with information related to held funds to health management system 210, as shown in step 322. Health management system 210 further forwards this information to TPA 212, as shown in step 324. FIG. 3, thus completes the process 300 for authorization of payment for transactions by a CM 202 at a merchant 204.

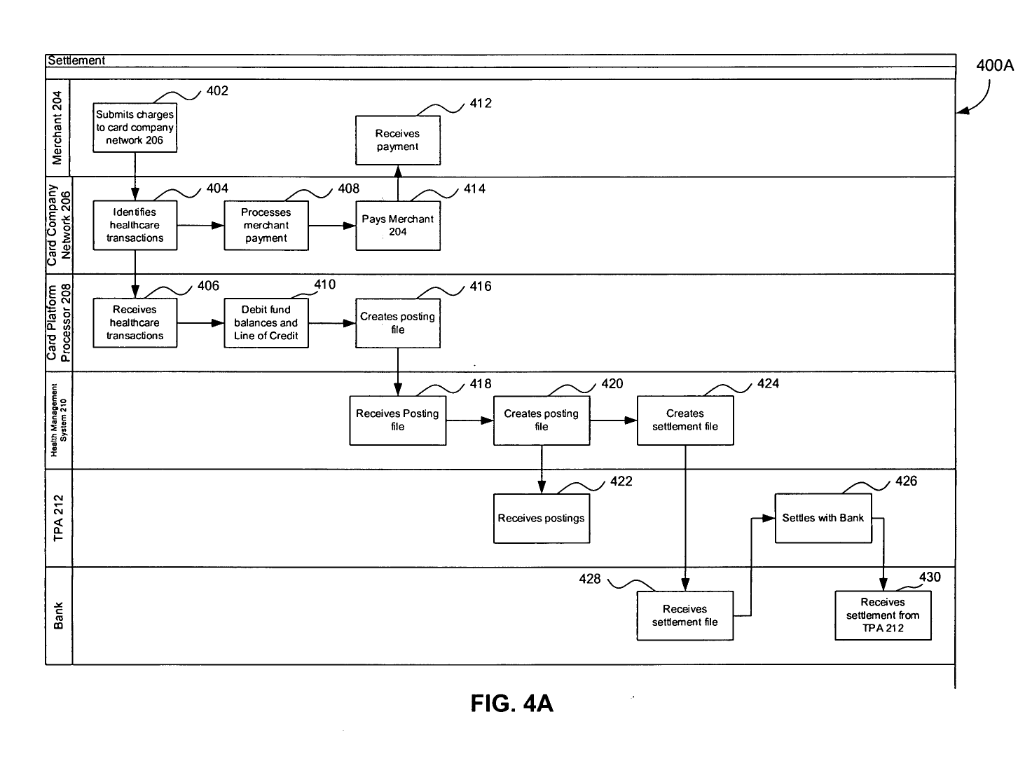

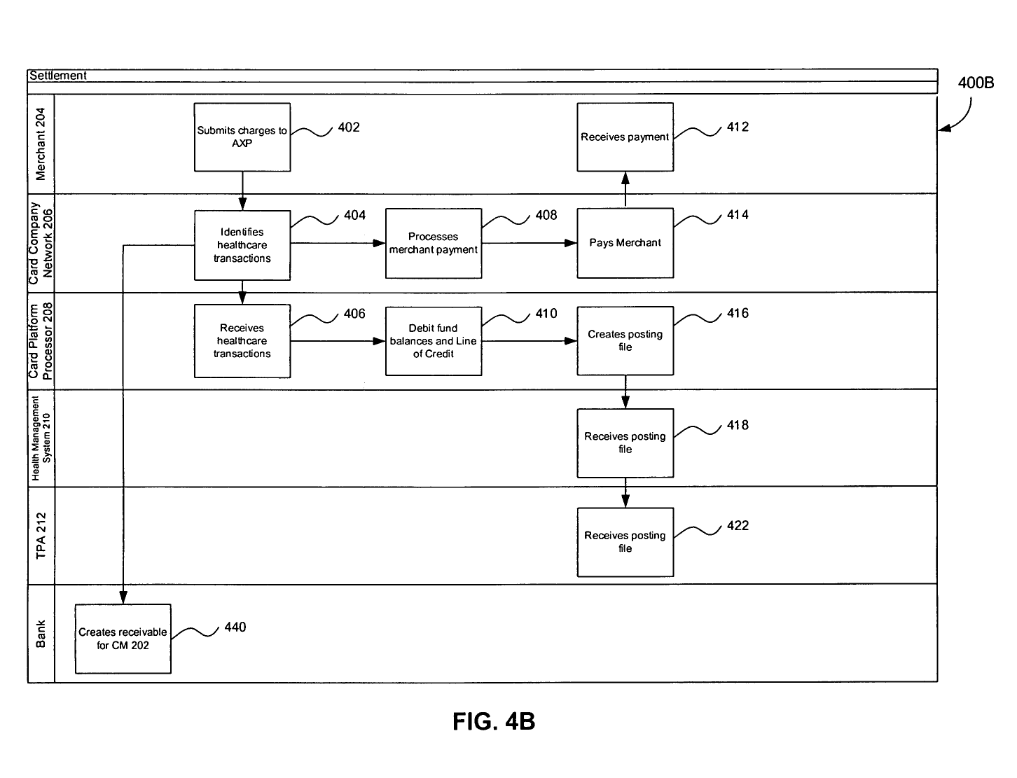

FIG. 4A illustrates a process 400A of settlement of pending charges billed to CM 202. In step 402, merchant 204 submits charges to card company network 206. Card company network 206 identifies what type of healthcare transaction this charge corresponds to, as shown in step 404. Card company network 206 can process this request for payment and then pay merchant 204 who issues a receipt for payment, as shown in steps 408, 414 and 412, respectively.

Card company network 404 can also send the charges to card platform processor 208, as shown in step 406. Card platform processor 208, in step 410, can then debit CM 202's tax advantaged account or a line of credit, as the case might be.

Card processor platform 208 further creates a file in step 416 comprising settlement information. This file is then forwarded to health management system 210, in step 418. Health management system 210 further modifies this file according to relevant information related to CM 202's tax advantaged accounts, as shown in step 420. The modified file is sent to TPA 212 as a posting, as shown in step 422.

In step 424, health management system 210 uses the modified file to create a settlement file which is sent to a bank associated with card company network 206, as shown in step 428. On the basis of this settlement file, TPA 212 and the bank settle any remaining pending charges, as shown by steps 426 and 430.

FIG. 4B shows an embodiment where a line of credit account is directly charged for a CM 202 by a bank associated with card company network 206. In the scenario depicted by process 400B, once card company network 206 identifies healthcare transactions as shown in step 404, it also requests its associated bank to create a receivable (e.g., a statement) for CM 202, as shown is step 440. This results in charges for items purchased by CM 202 to directly hit his or her line of credit. In such a scenario, steps 424, 426, 428 and 430 of FIG. 4A are eliminated and there is no settlement process needed between TPA 212, health management system 210 and the associated bank. Instead, as shown in step 422, TPA 212 and health management system 210 merely receive information in the form of a posting file and do not necessarily need to process that information any further.

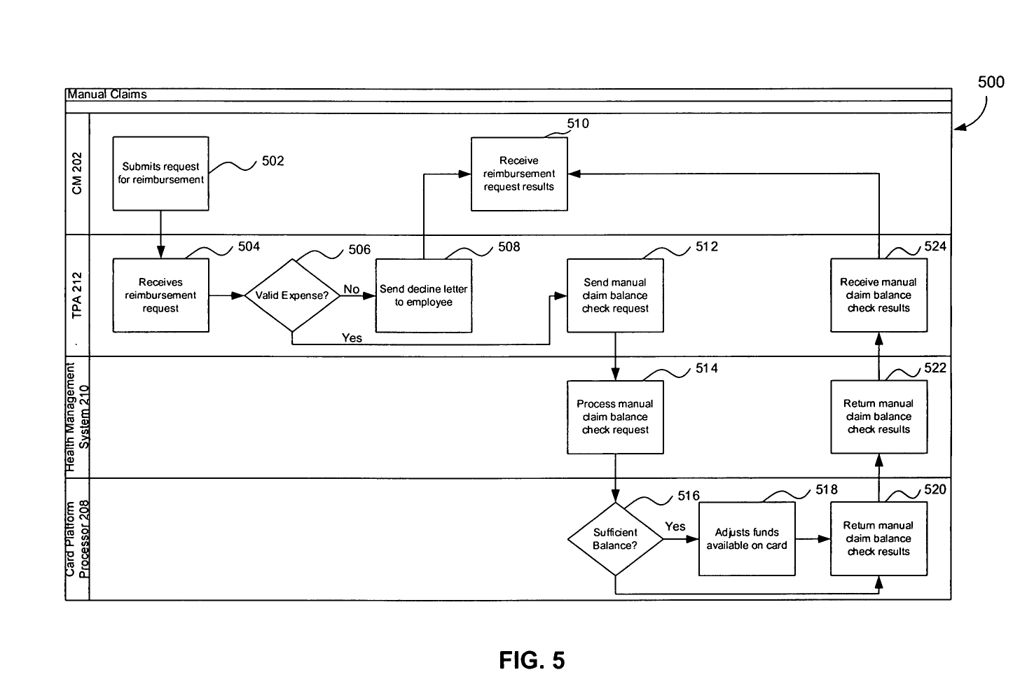

FIG. 5 illustrates a process 500 by which a CM 202 can manually settle any charges associated with various transactions. In step 502, CM 202 submits a request for reimbursement of payments for any potentially eligible healthcare purchases. TPA 212 receives these requests in step 504 and in step 506 determines if the request is valid or not. If not, TPA 212 sends a decline message to CM 202 which CM 202 sees as a reimbursement request details result, as shown in steps 508 and 510.

However, if the request is valid, TPA 212 communicates a manual claim balance check request to health management system 210, as shown in step 512. In step 514, health management system 210 will process this request for manual claim balance check and forward it to card processor platform 208. In step 516, card processor platform 208 checks if there is a sufficient balance in CM 202's tax advantaged account. If yes, card processor platform adjusts funds available in CM 202's tax advantaged account, as shown in step 518 and goes to step 520. If not, card processor platform 208 directly goes to step 520. In step 520, card processor platform 208 returns manual claim balance check results to health management system 210. Health management system 210 forwards these results to TPA 212, as shown in step 522. TPA 212 then forwards these check results to CM 202, as shown in step 524. Thus, process 500 completes in step 510 where CM 202 receives a communication about settlement of reimbursement requests which CM 202 had manually initiated in step 502.

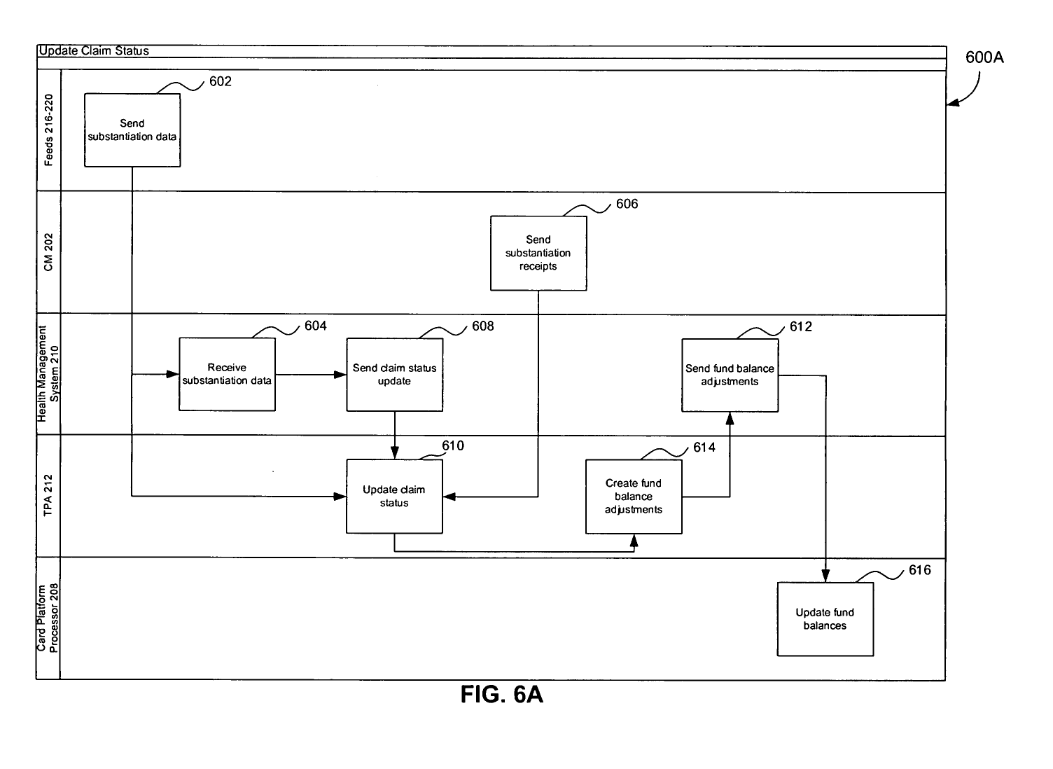

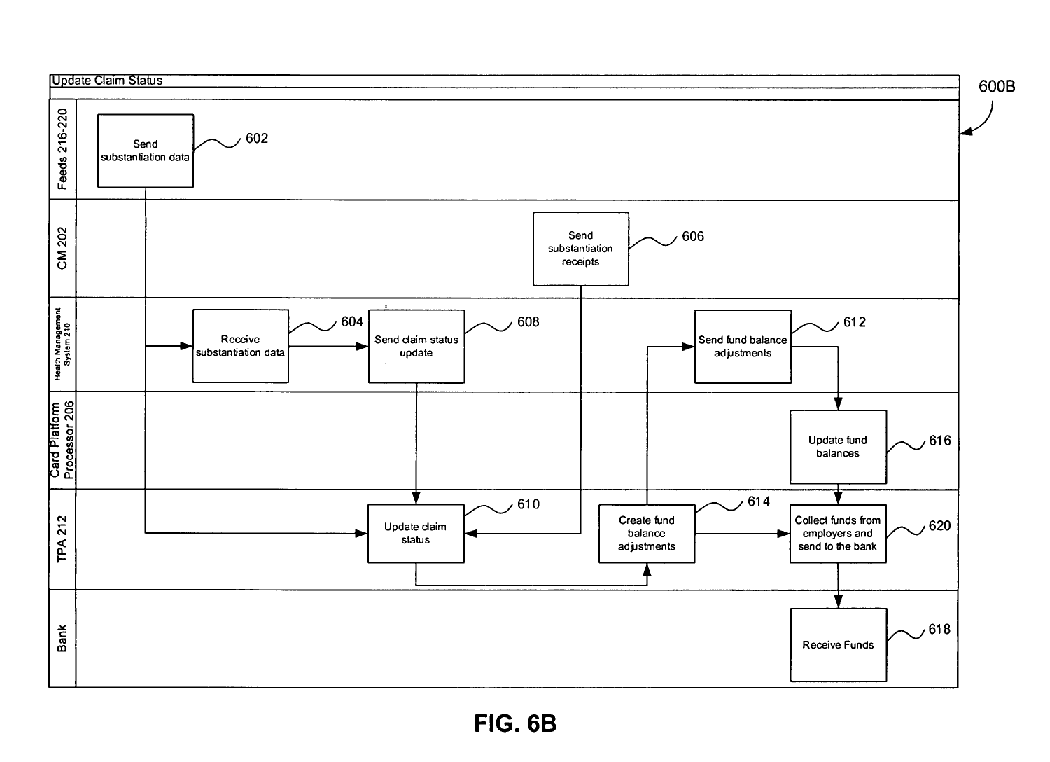

FIG. 6A illustrates a process 600A for updating claims status. Process 600A begins at step 602 with any of feeds 216-220 sending claims substantiation data to health management system 210. Health management system 210 receives substantiation data, as shown in step 604 and can then send a claim status update to TPA 212 as shown in step 608.

Claims substantiation data may also be forwarded directly to TPA 212, as shown in step 610, so that TPA 212 can post this data on TPA website portal 214. This can be done, for example, by CM 202 who sends claim substantiation receipts to TPA 212 as shown in step 606. Once TPA 212 updates claims status in step 610, it creates fund balance adjustments to CM 202's tax advantaged accounts, as shown in step 614. These adjustments are then communicated back to health management system 210, as shown in step 612. Health management system 210 then forwards the fund balances information to card processor platform 208. This communication can be, for example, on a nightly basis. Card processor platform 208 then updates fund balances, as shown in 616.

In an alternative embodiment shown in FIG. 6B, process 600B describes a process similar to process 600A. In process 600B, TPA 212 additionally collects funds from employers of CM 202 and sends it to a bank associated with card company network 206. This is shown by steps 620 and 618 in FIG. 6B.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing consumer files using an ISO/IEC 7414-4 file structure; implementing a domain whereby a dedicated file is selected that exposes one or more elementary files containing one or more data sets; using data sets stored in consumer files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7414-6 data elements; stored as ungrouped data elements encoded using ISO/IEC Abstract Syntax Notation (ASN.1) as in ISO/IEC 8428 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial payment instrument or external to but affiliated with the financial payment instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial payment instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data onto the financial payment instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain consumers, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the payment instrument user at the stand alone device, the appropriate option for the action to be taken. The present invention may contemplate a data storage arrangement wherein the header or trailer, or header or trailer history, of the data is stored on the payment instrument in relation to the appropriate data.

One skilled in the art will also appreciate that, for security reasons, any databases, systems, devices, servers or other devices of system 200 may consist of any combination thereof at a single location or at multiple locations, wherein each database or system includes any of various suitable security features, such as firewalls, access codes, encryption, decryption, compression, decompression, and/or the like.

System 200 may be described herein in terms of functional block components and various processing steps. It should be appreciated that such functional blocks may be realized by any number of hardware and/or software components configured to perform the specified functions. For example, system 200 may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, system 200 may be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, system 200 may be embodied as a customization of an existing system, an add-on product, upgraded software, a stand-alone system, a distributed system, a method, a data processing system, a device for data processing, and/or a computer program product. Accordingly, system 200 may take the form of an entirely software embodiment, an entirely hardware embodiment, or an embodiment combining aspects of both software and hardware. Furthermore, system 200 may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

### IV. Example Implementations

The present invention (i.e., system 200, processes 300-600 or any part(s) or function(s) thereof) may be implemented using hardware, software or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the present invention. Rather, the operations are machine operations. Useful machines for performing the operations in the present invention may include general-purpose digital computers or similar devices.

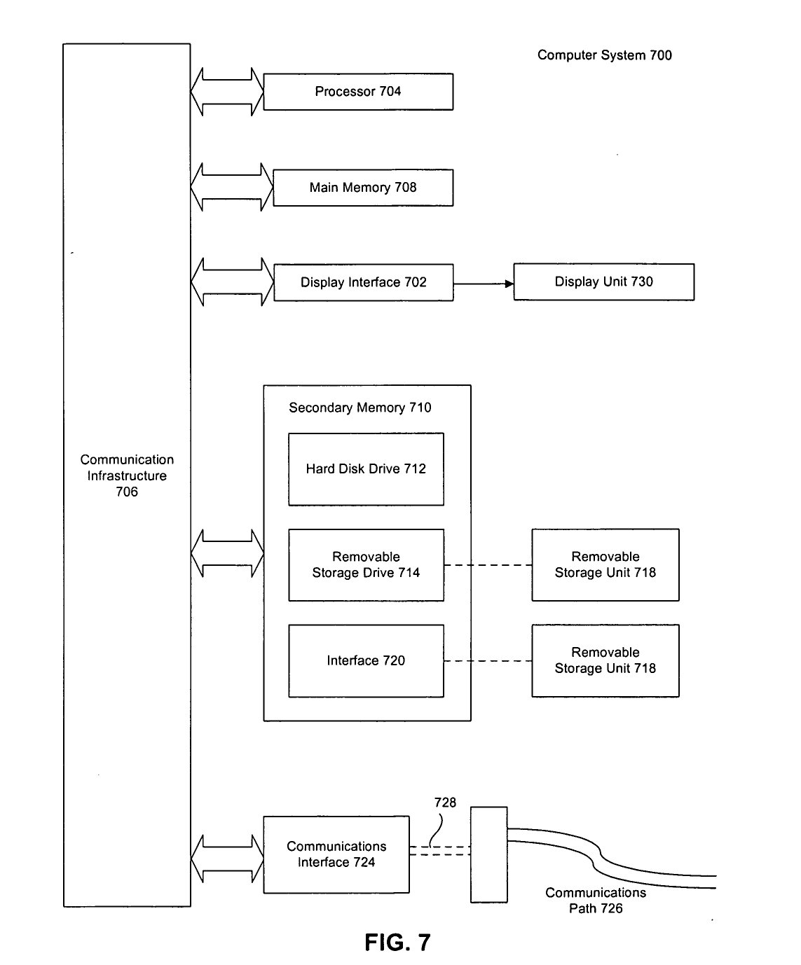

In fact, in accordance with an embodiment of the present invention, the present invention is directed towards one or more computer systems capable of carrying out the functionality described herein. An example of the computer systems includes a computer system 700, which is shown in FIG. 7.

Computer system 700 includes one or more processors, such as a processor 704. Processor 704 is connected to a communication infrastructure 706, for example, a communications bus, a cross over bar, a network, and the like. Various software embodiments are described in terms of this exemplary computer system 700. After reading this description, it will become apparent to a person skilled in the relevant art(s) how to implement the present invention using other computer systems and/or architectures.

Computer system 700 includes a display interface 702 that forwards graphics, text, and other data from communication infrastructure 706 (or from a frame buffer which is not shown in FIG. 7) for display on a display unit 730.

Computer system 700 also includes a main memory 708, such as random access memory (RAM), and may also include a secondary memory 710. Secondary memory 710 may include, for example, a hard disk drive 712 and/or a removable storage drive 714, representing a floppy disk drive, a magnetic tape drive, an optical disk drive, etc. Removable storage drive 714 reads from and/or writes to a removable storage unit 718 in a well known manner. Removable storage unit 718 represents a floppy disk, magnetic tape, optical disk, and the like. Removable storage unit 718 may be read by and written to by removable storage drive 714. As will be appreciated, removable storage unit 718 includes a computer usable storage medium having stored therein, computer software and/or data.

In accordance with various embodiments of the present invention, secondary memory 710 may include other similar devices for allowing computer programs or other instructions to be loaded into computer system 700. Such devices may include, for example, a removable storage unit such as removable storage unit 718, and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from removable storage unit 418 to computer system 400.

Computer system 700 may also include a communication interface 724. Communication interface 724 allows software and data to be transferred between computer system 700 and external devices. Examples of communication interface 724 may include a modem, a network interface (such as an Ethernet card), a communications port, a Personal Computer Memory Card International Association (PCMCIA) slot and card, and the like. Software and data transferred via communication interface 724 are in the form of a plurality of signals, hereinafter referred to as signals 728, which may be electronic, electromagnetic, optical or other signals capable of being received by communication interface 724. Signals 728 are provided to communication interface 724 via a communication path (e.g., channel) 726. Communication path 726 carries signals 728 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 714, a hard disk installed in hard disk drive 712, signals 728, and the like. These computer program products provide software to computer system 700. The present invention is directed to such computer program products.

Computer programs (also referred to as computer control logic) are stored in main memory 708 and/or secondary memory 710. Computer programs may also be received via communication interface 724. Such computer programs, when executed, enable computer system 700 to perform the features of the present invention, as discussed herein. In particular, the computer programs, when executed, enable processor 704 to perform the features of the present invention. Accordingly, such computer programs represent controllers of computer system 700.

In accordance with an embodiment of the present invention, where the present invention is implemented using software, the software may be stored in a computer program product and loaded into computer system 700 using removable storage drive 714, hard disc drive 712 or communication interface 724. The control logic (software), when executed by processor 704, causes processor 704 to perform the functions of the present invention as described herein.

In another embodiment, the present invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the present invention is implemented using a combination of both the hardware and the software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for substantiating a purchase from a merchant, comprising:
(a) generating a receipt for a purchase that includes at least one of healthcare and non-healthcare items;
(b) verifying a merchant category code for the merchant;
(c) capturing purchase details;
(d) reading a transaction instrument at a point of sale;
(e) encrypting data stored in the card;
(f) sending the encrypted data and purchase details to a card platform;
(g) authorizing payment for eligible healthcare items purchased from a merchant having a verified merchant category code; and
(h) transferring payment of non-eligible healthcare items to a third party administrator.

2. The method of claim 1, wherein the healthcare items in step (a) further comprise:
healthcare items eligible for benefits under a Federal Savings Account, a Health Reimbursement Arrangement or a Health Savings Account; and
healthcare items not eligible for benefits under a Federal Savings Account, a Health Reimbursement Arrangement or a Health Savings Account.

3. The method of claim 1, wherein the card platform comprises a processor to perform computations related to the payment.

4. The method of claim 1, wherein step (h) further comprises automatic substantiation of purchases.

5. The method of claim 1, wherein step (e) comprises decrypting according to RSA algorithm.

6. The method of claim 1, wherein step (h) further comprises uploading information related to a card member initiating the purchase to a third party website.

7. The method of claim 6, further comprising:
the third party website manually substantiating claims for purchases made by a card member.

8. A system for substantiation of claims for a purchase from a merchant made using a transaction instrument, comprising:
a point of sale device to read the electronic card, wherein data contained in the transaction instrument can be read by the point of sale device at a merchant location;
a third party portal maintained by a third party administrator for online purchase and payment, wherein data contained in the transaction instrument can be read at a third party website by means of a secure validation scheme;
means for encrypting the data stored in the card;
a transmission path for carrying encrypted data;
a card processing platform to run a credit check on a card member associated with the transaction instrument and to authorize payment for a purchase;
a health management system to determine eligibility of the purchases for tax benefits; and
means decrypting data associated with the transaction instrument.

9. The system of claim 8, wherein the means for encrypting data and decrypting data comprise encrypting and decrypting according to RSA algorithm.

10. The system of claim 8, wherein the healthcare management system receives input from at least one of a merchant line-item-detail database, a pharmacy benefits manager module and an insurer database.

11. The system of claim 8, wherein the third party portal can send adjustment instructions to the health management system based upon requests from the card member.

12. The third party portal of claim 11, wherein the card member can manually request deductions from at least one of a Flexible Savings Account, a Health Reimbursement Arrangement or a Health Savings Account.

13. The system of claim 8, wherein the card processing platform sends regular end-of-cycle statements to the card member for amounts not substantiated in a predetermined time frame.

14. The system of claim 8, wherein the third party administrator communicates via at least one of letters or emails to the card member for non-substantiated transactions.

15. The system of claim 8, the third party portal comprises means for a card member to review his or her account and make changes to the account.

16. A computer program product comprising a computer usable medium having control logic stored therein for causing a computer to provide instructions for:
(a) generating a receipt for a purchase including at least one of healthcare and non-healthcare items from a merchant;
(b) verifying a merchant category code for the merchant;
(c) capturing purchase details;
(d) reading a transaction instrument at a point of sale;
(e) encrypting data stored in the transaction instrument;
(f) sending the encrypted data to a card platform;
(g) authorizing payment for eligible healthcare items purchased from a merchant having a verified merchant category code;
(h) transferring payment of non-eligible healthcare items to third party administrator; and
(i) using a third party website for manually substantiating claims for purchases made by a card member.
